(19) United States
(12) Patent Application Publication
(10) Pub. No.: US 2017/0266628 A1
(43) Pub. Date: Sep. 21, 2017

(54) METHOD OF CLEANING A MEMBRANE CONTACTOR

(71) Applicant: Pierce Kennedy and Associates D/B/A - N.J. Piece and Associates, Houston, TX (US)

(72) Inventors: Peter B. Kipp, Houston, TX (US); Stacy S. Truscott, Austin, TX (US)

(21) Appl. No.: 15/532,446

(22) PCT Filed: Dec. 1, 2015
(86) PCT No.: PCT/US15/63214

§ 371 Date: Jun. 1, 2017

Related U.S. Application Data
(60) Provisional application No. 62/086,069, filed on Dec. 1, 2014.

(51) Int. Cl. B01D 71/52; B01D 69/08; C02F 1/44; B01D 71/26; B01D 71/30; B01D 71/48; B01D 65/02; B01D 61/24

(52) U.S. Cl. CPC B01D 71/52; B01D 65/02; B01D 69/08; B01D 61/246; B01D 71/26; B01D 71/30; B01D 71/48; C02F 1/44; B01D 2325/38; C02F 2101/32

(57) ABSTRACT

The present invention includes a method of cleaning a membrane contactor comprising: connecting a membrane contactor having a first and a second surface, the membrane contactor being in liquid communication with a first and a second liquid circulation loop; rerouting the source of oil-containing liquid from the membrane contactor; draining the oil-containing liquid in contact with the first surface of the membrane contactor via a drain; circulating a cleaning oil over the first surface of the membrane contactor; pumping a collection fluid over the second surface of the membrane contactor; and contacting the oil-containing liquid with the first surface of the membrane contactor under pressure to maximize oil coalescence at the first surface of the membrane contactor while also circulating the collection fluid over the second surface of the membrane contactor to capture the coalesced oil.

### TECHNICAL FIELD OF THE INVENTION

The present invention relates in general to the field of oil recovery, and more particularly, to a novel method for using and/or cleaning a membrane contactor for use in oil recovery.

### BACKGROUND OF THE INVENTION

Without limiting the scope of the invention, its background is described in connection with the operation of devices that use a membrane.

One such example is taught in Chinese Patent Application CN102861515A, entitled, “Filtering membrane cleaning agent and cleaning method of filtering membrane”. Briefly, this application is said to teach a filtering membrane cleaning agent and a cleaning method of a filtering membrane, which can easily remove dirt of a filtering membrane used for treating drainage containing oil content such as hydrocarbon compounds and aromatic compounds or difficultly-degraded coloring components. The filtering membrane cleaning agent of the invention comprises a mixed solution containing chlorine oxyacid or its salts and a surfactant, and is used for cleaning a filtering membrane used in drainage treatment; the concentration of the free chlorine of the chlorine oxyacid or its salts is 0.01-3.0 mass %.

Another example is U.S. Pat. No. 7,282,147 B2, entitled “Cleaning hollow core membrane fibers using vibration.” Briefly, these inventors are said to teach a hollow membrane filter elements and filter operable to remove solids, particulate and colloidal matter from a process fluid. Acoustic, vibration and ultrasonic energy is used to clean exterior portions of the hollow membrane filter elements to allow substantially continuous filtration of process fluids. The filtration system may be satisfactorily used with process fluids having a relatively high concentrations of solids, particulate and colloidal matter.

Another example is U.S. Pat. No. 5,938,922, issued to Fulk, et al., entitled, “Contactor for degassing liquids”. Briefly, these inventors teach a contactor for degassing liquids includes a perforated core, a plurality of microporous hollow fibers, and a shell. The fibers surround the core and have two ends, with a tube sheet that affixes the ends of the fibers. A baffle is located between the tube sheets, hollow fibers are closed at the baffle, and the shell encloses the fibers, tube sheets, and the baffle. The system for degassing liquids includes a source of liquid containing a gas, a source of vacuum, and the contactor. The cleaning of the membrane contactor described in U.S. Pat. No. 5,938,922 is described at, e.g., www.liquicel.com/uploads/documents/Cleaning%20Guide%20CG119_Rev8_7-11-12.pdf. Table 3 of the same outlines the cleaning steps of the same, namely, a wash with water at ambient to cold temperature, an alkaline wash, flushing of the alkaline wash, an acid rinse, followed by another water wash, and finally, the are lumens purged with gas. Use of a vacuum, surfactants, or a backpressure of less than 30 psig is contraindicated.

Yet another example is taught in U.S. Pat. No. 4,253,962 A, entitled “Non-destructive vibratory cleaning system for reverse osmosis and ultra filtration membranes.” Briefly, these inventors teach a non-destructive vibratory cleaning of reverse osmosis and ultra filtration membranes by positioning a plurality of ultrasonic transducers and using a frequency modulating sweep system to vibrate various and different transducers for vibrating liquid adjacent the membrane to be cleaned while preventing long period standing waves from being produced and/or continuously move a transducer along a filter module during cleaning to provide intense ultrasonic energy while preventing formation of membrane destructive standing waves.

### SUMMARY OF THE INVENTION

In one embodiment, the present invention includes a method of cleaning a membrane contactor for removing an oil from an oil-containing liquid comprising: connecting one or more membrane contactors having a first and a second surface in fluid communication with an oil-containing liquid, to a first and a second liquid circulation loop; disconnecting the source of oil-containing liquid only from the one or more membrane contactors; draining the oil-containing liquid in contact with the first surface of the one or more membrane contactors; connecting the one or more membrane contactors to a first liquid circulation loop connected to a cleaning liquid reservoir that is in fluid communication with the first surface of one or more membrane contactors, and wherein the second liquid circulation loop is connected to a liquid collection reservoir that is in fluid communication with the second surface of one or more membrane contactors; circulating a cleaning oil over the first surface of the one or more membrane contactors; and reconnecting the oil-containing liquid with the first surface of the cleaned membrane contactor under pressure to maximize oil coalescence at the first surface of the one or more membrane contactors while capturing the cleaning oil at the second surface of the membrane, wherein the one or more membrane contactors have been at least partially cleaned. In one aspect, the method further comprises the step of restarting the flow of the oil-containing liquid over the first surface of the one or more membrane contactors. In another aspect, the oil-containing liquid is selected from at least one of an oil-rich stream, crude oil, transportation fuel, heating oil, refined petroleum products, growth media, fermentation broth, petrochemicals, bio-oils, renewable oils, vegetable oils, reclaimed oils, waste oils, oil industry liquid streams, oil contaminated water or brine, drilling mud, produced water and oil sands tailings. In another aspect, the oil-containing liquid is at least one of: not subjected to gravity separation prior to processing, subjected to gravity separation prior to processing, subjected to filtration prior to processing, or subjected to centrifugation prior to processing. In another aspect, the one or more membrane contactors comprise a hydrophobic membrane or membrane module that comprises hollow fiber microporous fibers. In another aspect, the one or more membrane contactors comprise a hydrophobic hollow fiber membrane comprises polyethylene, polypropylene, polyolefins, polyvinyl chloride (PVC), amorphous polyethylene terephthalate (PET), polyolefin copolymers, poly(etheretherketone) type polymers, surface modified polymers, mixtures or combinations thereof or a surface modified polymer that comprises polymers modified chemically at one or more halogen groups by corona discharge or by ion embedding techniques. In another aspect, the method further comprises an oil and gas separator in fluid communication with the second surface of the one or more membrane contactors. In another aspect, the apparatus operates at less than 100 psi. In another aspect, the apparatus operates at 5, 10, 20, 30, 40, 50, 60, 70, 80, 90, 95, 5 to 95, 10 to 90, 20 to 80, 30 to 70, 40 to 50, 5 to 15, 10 to 30, 20 to 40, 40 to 60, 50 to 70, 60 to 80, 80 to 90, or 90 to 95 psi. In another aspect, the method further comprises a particulate removal system that removes particulates from the oil-containing liquid prior to being circulated to the first surface of the membrane contactor, and optionally comprising a clog detector that detects a clog on the first surface of the membrane contactor.

In one embodiment, the present invention includes a method of cleaning a membrane contactor for removing an oil from an oil-containing liquid comprising: connecting a membrane contactor having a first and a second surface, the membrane contactor being in liquid communication with a first and a second liquid circulation loop, wherein the first liquid circulation loop is connected to a cleaning liquid reservoir and is in fluid communication with the first surface of the membrane contactor, and wherein the second liquid circulation loop is connected to a liquid collection reservoir that is in fluid communication with the second surface of the membrane contactor, and wherein the first surface of the membrane contactor is further in liquid communication with a source of oil-containing liquid; rerouting the source of oil-containing liquid from the membrane contactor; draining the oil-containing liquid in contact with the first surface of the membrane contactor via a drain; circulating a cleaning oil over the first surface of the membrane contactor; pumping a collection fluid over the second surface of the membrane contactor; and contacting the oil-containing liquid with the first surface of the membrane contactor under pressure to maximize oil coalescence at the first surface of the membrane contactor while also circulating the collection fluid over the second surface of the membrane contactor to capture the coalesced oil, wherein the membrane contactor has been at least partially cleaned. In one aspect, the method further comprises the step of restarting the flow of the oil-containing liquid over the first surface of the membrane contactor. In another aspect, the oil-containing liquid is selected from at least one of an oil-rich stream, crude oil, transportation fuel, heating oil, refined petroleum products, growth media, fermentation broth, petrochemicals, bio-oils, renewable oils, vegetable oils, reclaimed oils, waste oils, oil industry liquid streams, oil contaminated water or brine, drilling mud, produced water and oil sands tailings. In another aspect, the oil-containing liquid is at least one of: not subjected to gravity separation prior to processing, subjected to gravity separation prior to processing, subjected to filtration prior to processing, or subjected to centrifugation prior to processing. In another aspect, the membrane contactor is a hydrophobic membrane or membrane module that comprises hollow fiber microporous fibers. In another aspect, the membrane contactor is a hydrophobic hollow fiber membrane comprises polyethylene, polypropylene, polyolefins, polyvinyl chloride (PVC), amorphous polyethylene terephthalate (PET), polyolefin copolymers, poly(etheretherketone) type polymers, surface modified polymers, mixtures or combinations thereof or a surface modified polymer that comprises polymers modified chemically at one or more halogen groups by corona discharge or by ion embedding techniques. In another aspect, the method further comprises an oil and gas separator in fluid communication with the second surface of the membrane contactor. In another aspect, the apparatus operates at less than 100 psi. In another aspect, the apparatus operates at 5, 10, 20, 30, 40, 50, 60, 70, 80, 90, 95, 5 to 95, 10 to 90, 20 to 80, 30 to 70, 40 to 50, 5 to 15, 10 to 30, 20 to 40, 40 to 60, 50 to 70, 60 to 80, 80 to 90, or 90 to 95 psi. In another aspect, the method further comprises a particulate removal system that removes particulates from the oil-containing liquid prior to being circulated to the first surface of the membrane contactor, and optionally comprising a clog detector that detects a clog on the first surface of the membrane contactor.

Yet another aspect of the present invention includes a method of cleaning a membrane contactor for removing an oil from an oil-containing liquid, wherein the membrane contactor has a first and a second surface, the membrane contactor being in liquid communication with a first and a second liquid circulation loop, wherein the first liquid circulation loop is connected to a cleaning liquid reservoir and is in fluid communication with the first surface of the membrane contactor, and wherein the second liquid circulation loop is connected to a liquid collection reservoir that is in fluid communication with the second surface of the membrane contactor, and wherein the membrane contactor is further in liquid communication with a source of oil-containing liquid, the method comprising; disconnecting the membrane contactor from the source of oil-containing liquid; draining the oil-containing liquid in contact with the first surface of the membrane contactor via a drain; circulating a cleaning oil over the first surface of the membrane contactor; pumping a collection fluid over the second surface of the membrane contactor; and contacting the oil-containing liquid with the first surface of the membrane contactor under partial pressure to maximize oil coalescence at the first surface of the membrane contactor while also circulating the collection fluid over the second surface of the membrane contactor, wherein the membrane contactor has been at least partially cleaned. In one aspect, the method further comprises the step of restarting the flow of the oil-containing liquid over the first surface of the membrane contactor. In another aspect, the oil-containing liquid is selected from at least one of an oil-rich stream, crude oil, transportation fuel, heating oil, refined petroleum products, growth media, fermentation broth, petrochemicals, bio-oils, renewable oils, vegetable oils, reclaimed oils, waste oils, oil industry liquid streams, oil contaminated water or brine, drilling mud, produced water and oil sands tailings. In another aspect, the membrane contactor is a hydrophobic membrane or membrane module that comprises hollow fiber microporous membranes. In another aspect, the membrane contactor is a hydrophobic hollow fiber membrane that comprises, for example, polyethylene, polypropylene, polyolefins, polyvinyl chloride (PVC), amorphous polyethylene terephthalate (PET), polyolefin copolymers, poly(etheretherketone) type polymers, surface modified polymers, mixtures or combinations thereof or a surface modified polymer that comprises polymers modified chemically at one or more halogen groups by corona discharge or by ion embedding techniques. In another aspect, the method further comprises an oil and gas separator in fluid communication with the second surface of the membrane contactor. In another aspect, the apparatus operates at less than 100 psi. In another aspect, the apparatus operates at 5, 10, 20, 30, 40, 50, 60, 70, 80, 90, 95, 5 to 95, 10 to 90, 20 to 80, 30 to 70, 40 to 50, 5 to 15, 10 to 30, 20 to 40, 40 to 60, 50 to 70, 60 to 80, 80 to 90, or 90 to 95 psi. In another aspect, the oil-containing liquid is at least one of: not subjected to gravity separation prior to processing, subjected to gravity separation prior to processing, subjected to filtration prior to processing, or subjected to centrifugation prior to processing. In another aspect, the method further comprises a particulate removal system that removes particulates from the oil-containing liquid prior to the oil-containing liquid contacting the first surface of the membrane contactor, and optionally comprising a clog detector that detects a clog at the membrane contactor.

Yet another aspect of the present invention includes a method of cleaning a membrane contactor for removing an oil from an oil-containing liquid, wherein the membrane contactor has a first and a second surface, the membrane contactor being in liquid communication with a first and a second liquid circulation loop, wherein the first liquid circulation loop is connected to a cleaning liquid reservoir and is in fluid communication with the first surface of the membrane contactor, and the second liquid circulation loop is connected to a liquid collection reservoir that is in fluid communication with the second surface of the membrane contactor, and wherein the membrane contactor is further in liquid communication with a source of oil-containing liquid, the method comprising; disconnecting the membrane contactor from the source of oil-containing liquid; draining the oil-containing liquid in contact with the first surface of the membrane contactor via a drain; circulating a cleaning oil over the first surface of the membrane contactor; pumping a collection fluid over the second surface of the membrane contactor; contacting the oil-containing liquid with the first surface of the membrane contactor under partial pressure to maximize oil coalescence at the first surface of the membrane contactor while also circulating the collection fluid over the second surface of the membrane contactor, wherein the membrane contactor has been at least partially cleaned; and restarting the flow of the oil-containing liquid over the first surface of the membrane contactor. In one aspect, the method further comprises the step of restarting the flow of the oil-containing liquid over the first surface of the one or more membrane contactors. In another aspect, the oil-containing liquid is selected from at least one of an oil-rich stream, crude oil, transportation fuel, heating oil, refined petroleum products, growth media, fermentation broth, petrochemicals, bio-oils, renewable oils, vegetable oils, reclaimed oils, waste oils, oil industry liquid streams, oil contaminated water or brine, drilling mud, produced water and oil sands tailings. In another aspect, the oil-containing liquid is at least one of: not subjected to gravity separation prior to processing, subjected to gravity separation prior to processing, subjected to filtration prior to processing, or subjected to centrifugation prior to processing. In another aspect, the one or more membrane contactors comprise a hydrophobic membrane or membrane module that comprises hollow fiber microporous fibers. In another aspect, the one or more membrane contactors comprise a hydrophobic hollow fiber membrane comprises polyethylene, polypropylene, polyolefins, polyvinyl chloride (PVC), amorphous polyethylene terephthalate (PET), polyolefin copolymers, poly(etheretherketone) type polymers, surface modified polymers, mixtures or combinations thereof or a surface modified polymer that comprises polymers modified chemically at one or more halogen groups by corona discharge or by ion embedding techniques. In another aspect, the method further comprises an oil and gas separator in fluid communication with the second surface of the one or more membrane contactors. In another aspect, the apparatus operates at less than 100 psi. In another aspect, the apparatus operates at 5, 10, 20, 30, 40, 50, 60, 70, 80, 90, 95, 5 to 95, 10 to 90, 20 to 80, 30 to 70, 40 to 50, 5 to 15, 10 to 30, 20 to 40, 40 to 60, 50 to 70, 60 to 80, 80 to 90, or 90 to 95 psi. In another aspect, the method further comprises a particulate removal system that removes particulates from the oil-containing liquid prior to being circulated to the first surface of the membrane contactor, and optionally comprising a clog detector that detects a clog on the first surface of the membrane contactor.

### BRIEF DESCRIPTION OF THE DRAWINGS

For a more complete understanding of the features and advantages of the present invention, reference is now made to the detailed description of the invention along with the accompanying figures and in which:

FIG. 1 shows the first step in the operation of the device with the oil-containing liquid flowing through the membrane contactor of the method of the present invention.

FIG. 2 shows the next step in the cleaning process with the flow of oil-containing liquid diverted.

FIG. 3 shows the cleaning-membrane draining step of the method of the present invention.

FIG. 4 shows the cleaning step in the process of the present invention, which includes circulating a cleaning oil over the first surface of the one or more membrane contactors.

FIG. 5 shows the cleaning-completion step of the method of the present invention.

FIG. 6 shows the cleaning-priming and restart step of the method of the present invention.

FIG. 7 shows the restart following cleaning step of the method of the present invention.

FIG. 8 shows another embodiment of the operation of the device and method of the present invention in which one or more additional membranes can be positioned in series or in parallel allowing for continuous use of the system while cleaning one or more membranes.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, the term “aqueous slurry” or “oil-containing liquid” encompasses water based liquids containing any of the following in any combination: insoluble oils (hydrocarbons and hydrocarbon-rich molecules of commercial value) such as an oil-rich stream, crude oil, transportation fuel, heating oil, refined petroleum products, growth media, fermentation broth, petrochemicals, bio-oils, renewable oils, vegetable oils, reclaimed oils, waste oils, oil industry liquid streams, oil contaminated water or brine, drilling mud, produced water and oil sands tailings), oils from living, dead, damaged and/or broken cells (or not), proteins and other cellular debris, including sugars, DNA, RNA, etc. The slurry may also contain a solvent that was used to pre-treat cells to liberate compounds of interest. The slurry may also contain dissolved gases. As used herein, the term “oil” refers to any hydrocarbons, including but not limited to, oil extracted from oil/gas formations, single hydrocarbon or hydrocarbon-rich molecules including any complex mixture of hydrocarbons, lipids, free fatty acids, triglycerides, aldehydes, etc. The term oil also includes, e.g., C₈ (jet fuel compatible), C₆₀ (motor oil compatible) and oils that are odd- or even-chain oils (and mixtures thereof), e.g., from C₆ to C₁₂₀. Some compounds are pure hydrocarbons, some have oxygen. Oil also comprises hydrophobic or lipophilic compounds.

As used herein, the term “pumping” includes all methods of pumping, propelling, or feeding fluid from one location to another employing hoses, lines, tubes, ducts, pipes, or pipelines including under pressure. It also includes gravity flow of fluid.

Unlike the prior art, the present invention is based on the discovery that it is possible to feed two immiscible liquids on one side of a hollow fiber membrane, e.g., the shell-side, to cause separation of oils using coalescence versus liquid extraction. By contrast, the prior art, e.g., U.S. Pat. Nos., 3,956,112; 5,252,220; and 6,436,290, are feeding one immiscible liquid on the shell side.

U.S. Pat. No. 3,956,112, issued to Lee, et al., is directed to a membrane solvent extraction. Briefly, this patent is said to describe a membrane solvent extraction system that is used to separate a dissolved solute from one liquid referred to as the carrier and into a second liquid, which is immiscible with the carrier and is referred to as the solvent. Therefore, the hollow fiber membrane is used to extract a solute through a solvent swollen membrane from one solvent liquid phase to the extracting solvent liquid with direct contact between the liquid phases only within the porous walls. The membrane extraction method has potential advantages over conventional solvent extraction in that it does not require a density difference and provides a large amount of contact area. The membrane extraction contactor and may be applied to molecular diffusion based mass transfer separation processes as the mechanism in separation, purification, pollutant removal and recovery processes. The Lee patent relies on liquid extraction, as the solvent swells the membrane filling the pores and providing a diffusional process to extract a dissolved solute from an immiscible liquid carrier.

The present invention uses coalescence to achieve the transfer of oil across the membrane, the component to be removed is essentially insoluble in the feed and we are recovering only the water insoluble liquid. In liquid extraction, the component to be removed is dissolved in the feed and the dissolved material is recovered.

In the present invention, the second immiscible liquid (hydrocarbon) is removed from the aqueous feed by coalescence on the surface of the fiber. By contrast, the prior art is removing a dissolved solute (possibly a hydrocarbon).

Finally, unlike the prior art, the present invention does not rely on diffusional mass transfer, but rather, wettability of the insoluble liquid on the fiber. The liquid extraction of the prior art relies on liquid-liquid partitioning, diffusional mass transfer and mass transfer resistances.

In conventional liquid-liquid extraction and coalescing processes involving large drops of oil (greater than 1,000 microns), the mixing and separation of the oil and water phases by a dispersive process is routinely practiced with relative ease. However, when the oil drops are significantly smaller in diameter (less than 10 microns) and solids are present, the complete separation of the immiscible liquids is extremely difficult, if not impossible using dispersive methods routinely practiced for larger oil droplets. When routine methods are applied to try to recover small oil droplets from water in the presence of solids (such as cells or cell debris), a solid-liquid-liquid emulsion layer is created resulting in an incomplete and inefficient separation of the two liquids. Therefore a new process is required that will allow for a more efficient separation and elimination of the solid-liquid-liquid-emulsion problem. The process of the present invention enables the recovery of micron and submicron sized insoluble oil drops from an aqueous slurry utilizing a novel non-dispersive process.

A non-dispersive process promotes a one-way flow of specific compounds into and through a membrane to remove the compounds from the shell side feed to the tube side. A non-dispersive separation process is currently used to remove dissolved gases from liquids such as the removal of dissolved oxygen from water to produce ultra pure water for the microelectronics industry. The present invention is a first successful demonstration of the application of non-dispersive processes to recover insoluble oil from water or aqueous slurries. The non-dispersive process disclosed herein uses a microporous hollow fiber membrane composed of hydrophobic fibers. The aqueous slurry containing the insoluble oil is fed on the shell-side of the hollow fiber module and a hydrocarbon-appropriate liquid, for example, a biodiesel, or similar oil recovered in previous application of the described process is fed on the tube side of the hollow fiber module as a recovery fluid. The aqueous phase passes around the outside of the large surface area of hydrophobic fibers containing the hydrophobic recovery fluid as it passes through and eventually out of the module. As the aqueous liquid with the insoluble oil drops passes through the module, the insoluble oil droplets coalesce on to the walls of the hydrophobic fibers and dissolve into the hydrocarbon-appropriate recovery fluid on the tube side of the module and are carried out of the module with the recovery fluid. In this process, the tube side recovery fluid does not make prolonged contact with the aqueous phase or disperse into the aqueous phase.

The absence of this mixing as hypothesized by the inventors prevents the formation of a solid-liquid-liquid emulsion, when solids were present, allowing insoluble oil to be recovered efficiently from an aqueous slurry containing solids. The above hypothesis was successfully demonstrated herein to efficiently recover insoluble oil from an aqueous mixture including cells without the formation of a solid-liquid-liquid emulsion.

In one aspect the hydrophobic membrane or membrane module comprises microporous hollow fiber membranes, selected from polyethylene, polypropylene, polyolefins, polyvinyl chloride (PVC), amorphous Polyethylene terephthalate (PET), polyolefin copolymers, poly(etheretherketone) type polymers, surface modified polymers, mixtures or combinations thereof The surface modified polymers comprise polymers modified chemically at one or more halogen groups or by corona discharge or by ion embedding techniques.

In yet another aspect of the method of the present invention, when using one or more counterflowing collection fluids, these may comprise hydrophobic liquids, alkanes such as hexane, crude oil, refined petroleum products, aromatic solvents such as benzene, toluene, ethers such as diethyl ether, halogenated solvents such as chloroform, dichloromethane, and esters such as ethyl acetate. In one aspect the counterflowing non-polar collection fluid comprises algal oils, components of biodiesels selected from monoglycerides, diglycerides, triglycerides, and fatty acid methyl esters.

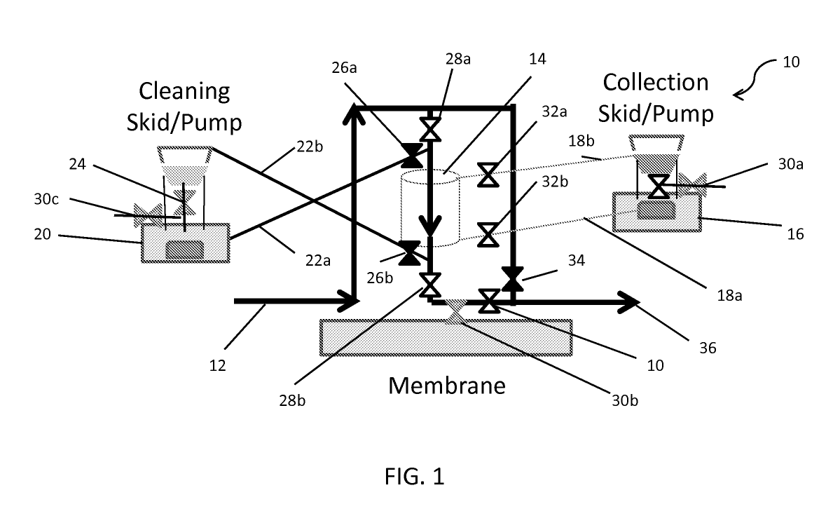

FIG. 1 shows the first step in the operation of the device 10 and method of the present invention. Under normal operations, a liquid 12 (e.g., water, oil, oil-containing water or water containing-oil) flows following the arrows through a membrane 14, on either the tube or shell side, wherein oil is removed and collected in the collection skid tank 16 via conduits 18a, 18b. A cleaning skid tank 20 is charged with oil. Depicted with connections 22a, 22b, but the pump 24 is off and the valves 26a, 26b are closed. Valves are shown as open (white interior) or closed (filled-in). Drains/sample ports 30a, 30b, 30c are shown as valves that are gray scale. In one version, the membrane and related valves are mounted on a skid, a vehicle, are provided in a kit, are mounted, and/or are provided in an enclosure.

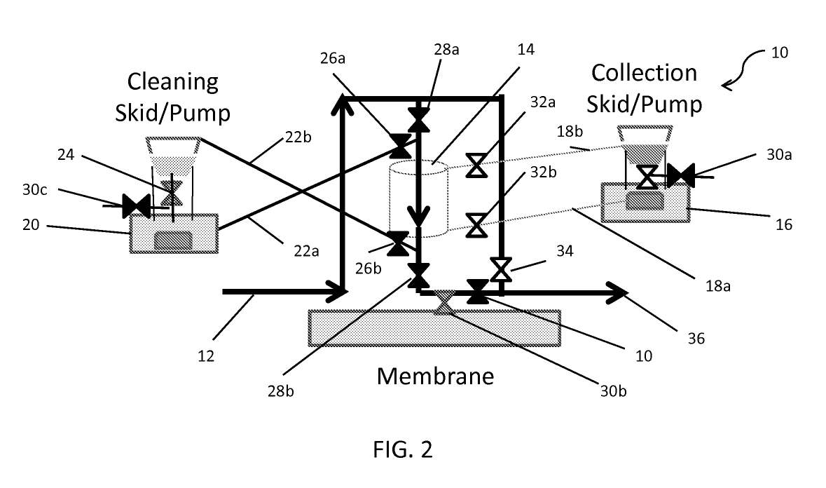

FIG. 2 shows the next step in the process, with the flow of liquid/water diverted. The various valve positions are changed to divert the water stream 12 around the membrane through valve 34. With water bypassing the membrane 14, the membrane 14 can be drained and cleaned. The membrane 14 is not under pressure once the water stream is diverted. Valves are shown as open (32a, 32b and 34) or closed (26a, 26b, 28a, 28b, 10). Drains/sample ports 30b is shown closed as gray with black borders.

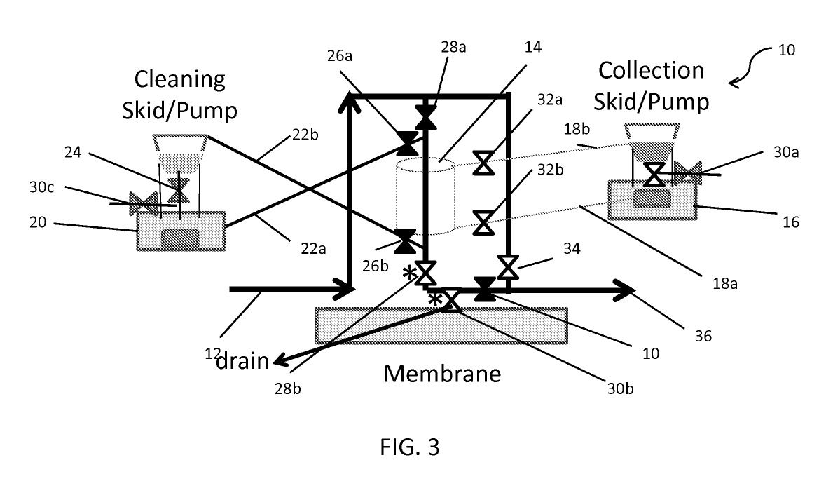

FIG. 3 shows the cleaning-membrane draining step, in which the various valve positions are changed to drain the membrane, if necessary. In this figure, the open valves are 32a, 32b, 34, 28b and drain 30b. In some cases, removing water may be beneficial and some bulk solids may pass with the drained water. After draining, the indicated (*) valves 28b, 30b are returned to the closed position.

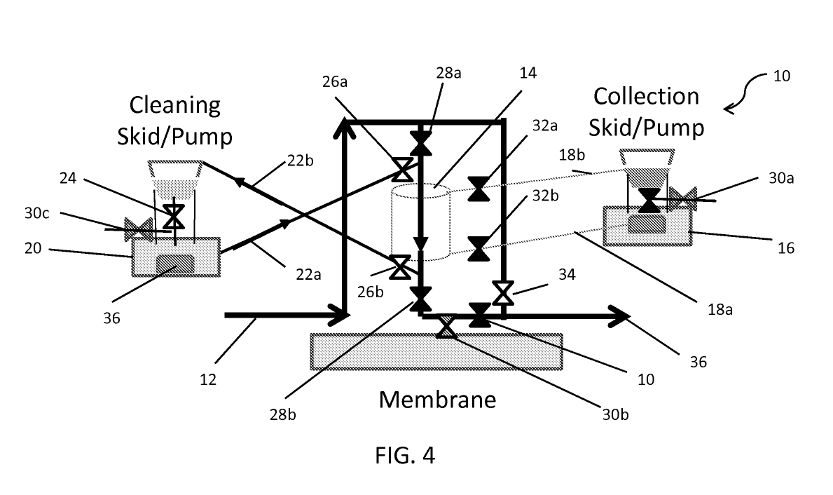

FIG. 4 shows the next step in the cleaning process. The valves on the collection lines 32a, 32b are closed. The cleaning pump 20 is started and the valves 26a, 26b on the cleaning lines 22a, 22b are opened. A cleaning oil is circulated through the shell side of the membrane 14 at suitable flows and pressures. The cleaning fluid becomes a mixture of oil, residual water and materials removed from the membrane 14. A filter unit 36 can be used inside the cleaning fluid tank and pump 20 to remove solids from the stream as it recirculates to the tank. Valves 26a, 26b, and 34 are shown open, while valves 28a, 28b, 10, 32a and 32b remain closed. Drains/sample ports 30b may remain open or closed.

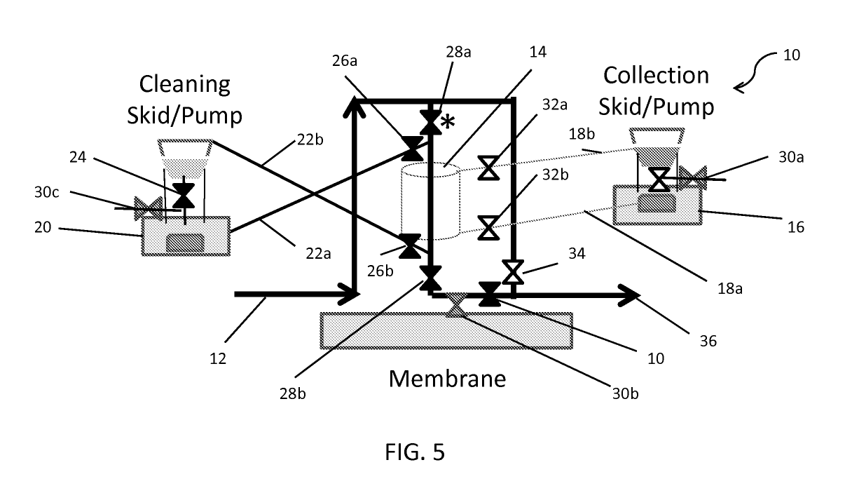

FIG. 5 shows the cleaning - completion step of the process. The cleaning pump 20 is shut off and valves 26a, 26b on the cleaning lines 22a, 22b are closed. The shell side of the membrane 14 is generally full of oil. Valves 32a, 32b on the collecting lines 18a, 18b are opened, and the collection fluid pump 16 may be used. The water stream pressure is restarted through the membrane 14 by opening only the indicated valve 28a (*). The open valves are 32a, 32b and 34, with the closed valves being 26a, 26b, 28a, 28b, and 10. Drains/sample ports 30b may remain open or closed.

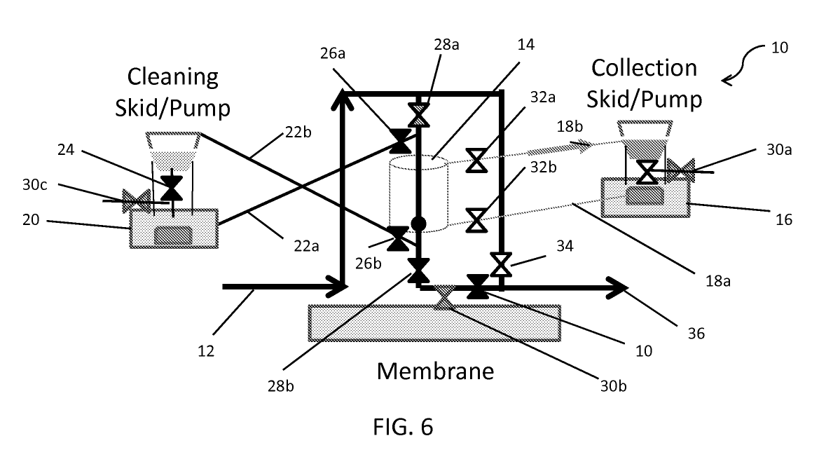

FIG. 6 shows the cleaning-priming and restart step of the process. In this step, the water stream valve 28a is partially opened, and the shell side of the membrane 14 is re-pressurized, creating ideal conditions for high oil flux across the membrane of the oil coalesced at the surface of the membrane 14. Water flow is not restored, as the outlet valve 28b remains closed. The cleaning oil in the membrane 14 rapidly moves through the tubes of the membrane into the collection skid 16, e.g., the collection skid tank. Water fills the shell side of the membrane 14, effectively lifting oil out of the piping below the membrane and into the working surface of the shell side of the membrane 14. In this step the open valves are 32a, 32b and 34, with 28a partially open. The closed valves are 26a, 26b, 28b, and 10. Drains/sample ports 30b may remain open or closed.

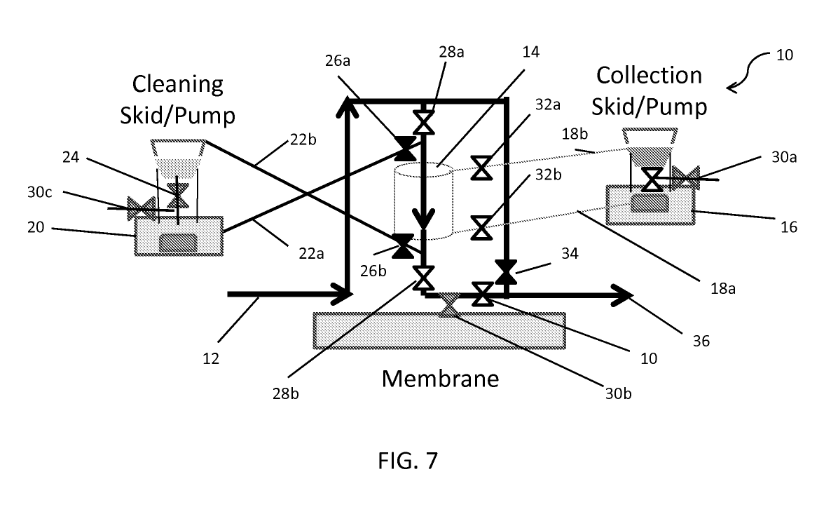

Finally, FIG. 7 shows the restart following cleaning step of the process. The residual cleaning oil coats the shell side surface of the membrane 14 and the movement of the cleaning oil through to the collection tank serves to clean membrane pores. The membrane 14 is cleaned and primed. A volume of the cleaning oil is now in the collection tank of the collection skid/pump 16 as clean oil. The remaining cleaning oil is in the cleaning tank as are the water and solids. The cleaning tank can be drained and the cleaning oil can be reused. Valves 28a, 28b, 10, 32a, 32b are returned to the normal operation position.

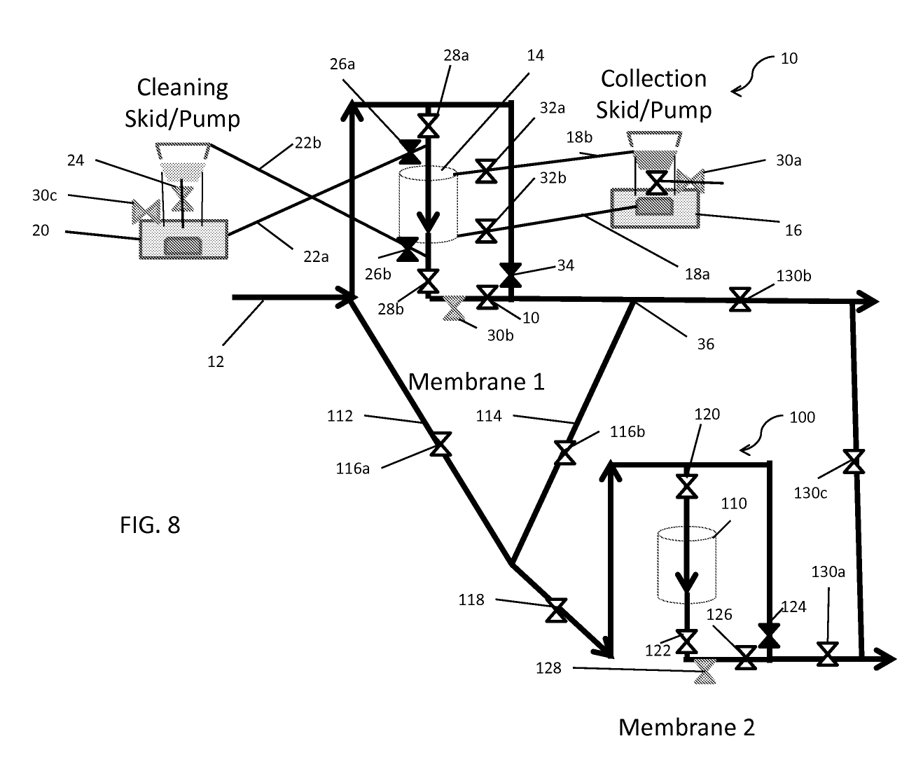

FIG. 8 shows another embodiment of the operation of the device and method of the present invention in which one or more additional membranes can be positioned in series or in parallel allowing for continuous use of the system while cleaning one or more membranes. FIG. 8 shows operation of the device 10 and 100 and method of the present invention. Under normal operations, a conduit 112 and/or 114 that carries the liquid (e.g., water, oil, oil-containing water or water containing-oil) flows following the arrows through a membrane 110, on either the tube or shell side while, e.g., device 10 is undergoing a cleaning operation and the flow is diverted into device 100. Valves are shown as open (white interior) or closed (filled-in). Various valves 116a, 116b, 118, 120, 122, 124, 126 are shown and can be controlled to allow operation of the device 100 while cleaning device 10, including, e.g., drain 128. Additional valves 130a, 130b, and 130c are show that help control the outflow from the devices 10 and 100. Of course, the device 100 can also be connected to the same or different cleaning skid/collection devices depending on the need (not depicted). Further, additional membrane devices can also be connected in series or parallel with devices 10 and/or 100 depending on the need for operation in series, parallel and/or for collection or cleaning operations. In one version, the devices 10 and 100 that include the membrane (e.g., membrane 14 and 110) and related valves are mounted on a skid, a vehicle, are provided in a kit, are mounted, and/or are provided in an enclosure.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A method of cleaning a membrane contactor for removing an oil from an oil-containing liquid comprising:
connecting one or more membrane contactors having a first and a second surface in fluid communication with an oil-containing liquid, to a first and a second liquid circulation loop;
disconnecting the source of oil-containing liquid only from the one or more membrane contactors;
draining the oil-containing liquid in contact with the first surface of the one or more membrane contactors;
connecting the one or more membrane contactors to a first liquid circulation loop connected to a cleaning liquid reservoir that is in fluid communication with the first surface of one or more membrane contactors, and wherein the second liquid circulation loop is connected to a liquid collection reservoir that is in fluid communication with the second surface of one or more membrane contactors;
circulating a cleaning oil over the first surface of the one or more membrane contactors; and
reconnecting the oil-containing liquid with the first surface of the cleaned membrane contactor under pressure to maximize oil coalescence at the first surface of the one or more membrane contactors while capturing the cleaning oil at the second surface of the membrane, wherein the one or more membrane contactors have been at least partially cleaned.

2. The method of claim 1, wherein the oil-containing liquid is selected from at least one of an oil-rich stream, crude oil, transportation fuel, heating oil, refined petroleum products, growth media, fermentation broth, petrochemicals, bio-oils, renewable oils, vegetable oils, reclaimed oils, waste oils, oil industry liquid streams, oil contaminated water or brine, drilling mud, produced water and oil sands tailings.

3. The method of claim 1, wherein the oil-containing liquid is at least one of: not subjected to gravity separation prior to processing, subjected to gravity separation prior to processing, subjected to filtration prior to processing, or subjected to centrifugation prior to processing.

4. The method of claim 1, wherein the one or more membrane contactors comprise a hydrophobic membrane or membrane module that comprises hollow fiber microporous fibers.

5. The method of claim 1, wherein the one or more membrane contactors comprise a hydrophobic hollow fiber membrane that comprises polyethylene, polypropylene, polyolefins, polyvinyl chloride (PVC), amorphous polyethylene terephthalate (PET), polyolefin copolymers, poly(etheretherketone) type polymers, surface modified polymers, mixtures or combinations thereof or a surface modified polymer that comprises polymers modified chemically at one or more halogen groups by corona discharge or by ion embedding techniques.

6. The method of claim 1, further comprising an oil and gas separator in fluid communication with the second surface of the membrane contactor.

7. The method of claim 1, wherein the apparatus operates at less than 100 psi.

8. The method of claim 1, wherein the apparatus operates at 5, 10, 20, 30, 40, 50, 60, 70, 80, 90, 95, 5 to 95, 10 to 90, 20 to 80, 30 to 70, 40 to 50, 5 to 15, 10 to 30, 20 to 40, 40 to 60, 50 to 70, 60 to 80, 80 to 90, or 90 to 95 psi.

9. The method of claim 1, wherein the apparatus further comprises a particulate removal system that removes particulates from the oil-containing liquid prior to the oil-containing liquid contacting the first surface of the membrane contactor, and optionally comprising a clog detector that detects a clog at the membrane contactor.

10. A method of cleaning a membrane contactor for removing an oil from an oil-containing liquid, wherein the membrane contactor has a first and a second surface, the membrane contactor being in liquid communication with a first and a second liquid circulation loop, wherein the first liquid circulation loop is connected to a cleaning liquid reservoir and is in fluid communication with the first surface of the membrane contactor, and wherein the second liquid circulation loop is connected to a liquid collection reservoir that is in fluid communication with the second surface of the membrane contactor, and wherein the membrane contactor is further in liquid communication with a source of oil-containing liquid, the method comprising:
disconnecting the membrane contactor from the source of oil-containing liquid;
draining the oil-containing liquid in contact with the first surface of the membrane contactor via a drain;
circulating a cleaning oil over the first surface of the membrane contactor;
pumping a collection fluid over the second surface of the membrane contactor; and
contacting the oil-containing liquid with the first surface of the membrane contactor under partial pressure to maximize oil coalescence at the first surface of the membrane contactor while also circulating the collection fluid over the second surface of the membrane contactor, wherein the membrane contactor has been at least partially cleaned.

11. The method of claim 10, wherein the oil-containing liquid is selected from at least one of an oil-rich stream, crude oil, transportation fuel, heating oil, refined petroleum products, growth media, fermentation broth, petrochemicals, bio-oils, renewable oils, vegetable oils, reclaimed oils, waste oils, oil industry liquid streams, oil contaminated water or brine, drilling mud, produced water and oil sands tailings.

12. The method of claim 10, wherein the membrane contactor is a hydrophobic membrane or membrane module that comprises hollow fiber microporous membranes.

13. The method of claim 10, wherein the membrane contactor is a hydrophobic hollow fiber membrane comprises polyethylene, polypropylene, polyolefins, polyvinyl chloride (PVC), amorphous polyethylene terephthalate (PET), polyolefin copolymers, poly(etheretherketone) type polymers, surface modified polymers, mixtures or combinations thereof or a surface modified polymer that comprises polymers modified chemically at one or more halogen groups by corona discharge or by ion embedding techniques.

14. The method of claim 10, further comprising an oil and gas separator in fluid communication with the second surface of the membrane contactor.

15. The method of claim 10, wherein the apparatus operates at less than 100 psi.

16. The method of claim 10, wherein the apparatus operates at 5, 10, 20, 30, 40, 50, 60, 70, 80, 90, 95, 5 to 95, 10 to 90, 20 to 80, 30 to 70, 40 to 50, 5 to 15, 10 to 30, 20 to 40, 40 to 60, 50 to 70, 60 to 80, 80 to 90, or 90 to 95 psi.

17. The method of claim 10, wherein the oil-containing liquid is at least one of: not subjected to gravity separation prior to processing, subjected to gravity separation prior to processing, subjected to filtration prior to processing, or subjected to centrifugation prior to processing.

18. The method of claim 10, further comprising a particulate removal system that removes particulates from the oil-containing liquid prior to the oil-containing liquid contacting the first surface of the membrane contactor, and optionally comprising a clog detector that detects a clog at the membrane contactor.

19. A method of cleaning a membrane contactor for removing an oil from an oil-containing liquid comprising:
connecting a membrane contactor having a first and a second surface, the membrane contactor being in liquid communication with a first and a second liquid circulation loop, wherein the first liquid circulation loop is connected to a cleaning liquid reservoir and is in fluid communication with the first surface of the membrane contactor, and wherein the second liquid circulation loop is connected to a liquid collection reservoir that is in fluid communication with the second surface of the membrane contactor, and wherein the first surface of the membrane contactor is further in liquid communication with a source of oil-containing liquid;
rerouting the source of oil-containing liquid from the membrane contactor;
draining the oil-containing liquid in contact with the first surface of the membrane contactor via a drain;
circulating a cleaning oil over the first surface of the membrane contactor;
pumping a collection fluid over the second surface of the membrane contactor; and
contacting the oil-containing liquid with the first surface of the membrane contactor under pressure to maximize oil coalescence at the first surface of the membrane contactor while also circulating the collection fluid over the second surface of the membrane contactor to capture the coalesced oil, wherein the membrane contactor has been at least partially cleaned.

20. A method of cleaning a membrane contactor for removing an oil from an oil-containing liquid, wherein the membrane contactor has a first and a second surface, the membrane contactor being in liquid communication with a first and a second liquid circulation loop, wherein the first liquid circulation loop is connected to a cleaning liquid reservoir and is in fluid communication with the first surface of the membrane contactor, and the second liquid circulation loop is connected to a liquid collection reservoir that is in fluid communication with the second surface of the membrane contactor, and wherein the membrane contactor is further in liquid communication with a source of oil-containing liquid, the method comprising;
disconnecting the membrane contactor from the source of oil-containing liquid;
draining the oil-containing liquid in contact with the first surface of the membrane contactor via a drain;
circulating a cleaning oil over the first surface of the membrane contactor;
pumping a collection fluid over the second surface of the membrane contactor;
contacting the oil-containing liquid with the first surface of the membrane contactor under partial pressure to maximize oil coalescence at the first surface of the membrane contactor while also circulating the collection fluid over the second surface of the membrane contactor, wherein the membrane contactor has been at least partially cleaned; and
restarting the flow of the oil-containing liquid over the first surface of the membrane contactor.

21. A method for continuous use of an apparatus for removing an oil from an oil-containing liquid comprising:
connecting two or more membrane contactors each having a first and a second surface in fluid communication with an oil-containing liquid, to a first and a second liquid circulation loop, wherein during a cleaning operation of at least one of the two or more membrane contactors, the membrane contactor being cleaned is cleaned as follows:
disconnecting the source of oil-containing liquid only from the membrane contactor being cleaned;
draining the oil-containing liquid in contact with the first surface of the membrane contactor being cleaned;
connecting the membrane contactor being cleaned to a first liquid circulation loop connected to a cleaning liquid reservoir that is in fluid communication with the first surface of the membrane contactor, and wherein the second liquid circulation loop is connected to a liquid collection reservoir that is in fluid communication with the second surface of the membrane contactor; circulating a cleaning oil over the first surface of the membrane contactor; and
reconnecting the oil-containing liquid with the first surface of the cleaned membrane contactor under pressure to maximize oil coalescence at the first surface of the membrane contactor while capturing the cleaning oil at the second surface of the membrane, wherein the membrane contactor has been at least partially cleaned.

22. The method of claim 21, wherein the two or more membrane contactors are connected in parallel to the liquid source of oil.
